(19) United States
(12) Patent Application Publication
(10) Pub. No.: US 2014/0324781 A1
(43) Pub. Date: Oct. 30, 2014

(54) INPUT/OUTPUT (I/O) PROCEDURE FOR DATABASE BACKUP TO MASS STORAGE

(71) Applicants: Ellen L. Sorenson, Roseville, MN (US); Roger V. Ritchie, Black Forest, CO (US)

(72) Inventors: Ellen L. Sorenson, Roseville, MN (US); Roger V. Ritchie, Black Forest, CO (US)

(73) Assignee: Unisys Corporation, Blue Bell, PA (US)

(21) Appl. No.: 13/873,451

(22) Filed: Apr. 30, 2013

(51) Int. Cl. G06F 11/14

(52) U.S. Cl. CPC G06F 11/1448
USPC 707/640

(57) ABSTRACT

Databases may be backed up on a mass storage device. Storing the database backup on mass storage, rather than tape drive, allows operations, such as from a database manager, with large input/output to improve performance. A method of backing up a database to a mass storage device may include receiving, at a database manager, a call from a backup utility to copy data from a source file to a destination file, performing, at the database manager, a plurality of input/output requests, in response to the call, to copy data from the source file to the destination file, and returning, to the backup utility, status information regarding completion of the call Placing the database backup on mass storage can further enable use of that backup as a shadow or alternate database.

### FIELD OF THE DISCLOSURE

The instant disclosure relates to computer systems. More specifically, this disclosure relates to storage systems in computer systems.

### BACKGROUND

Backup and administrative operations often create copies of database files. A copy may be created on the same system, but have a different file name. Current solutions to create the database involve dumping and reloading the file. The dump operation to write the database to tape and subsequent reload operation to read/write a file from the tape add significant overhead. The conventional method is illustrated in FIG. 1, which is a flow chart illustrating a method of copying a database. At block 102, the database may be dumped to a tape drive. At block 104, the database may be reloaded from the tape, and at block 106, a copy of the database is created from the data reloaded from the tape.

The dump operation currently reads a database file, blocks the file information onto a tape, and records information about the tape and the dump in a history file for use during restoration and recovery. However, the dump and reload operations can take a significant amount of time, because the medium for the files is a tape. During the time consumed in dumping and reloading a database to and from a tape drive, the database may have significantly changed. When the goal is to have the backup copy of the database file as similar as possible to the source database, this dump and reload operation may be too slow.

### SUMMARY

Instead of performing a dump and reload operation, the dump and reload operation may be completed on a mass storage device, such as a flash drive, a hard disk drive, or a cloud storage system. In this case, data is copied from one mass storage device to another mass storage device. The method of creating a copy of the database may include reading the database, writing the database to an alternate database file, and/or recording the information in the dump history file for use during a later recovery.

The copy of the database may include alternate names from the original database. During creation of the database copy, the database file may be backed-up from an existing database file, and the database file may be populated from an existing database file with current data from another file.

According to one embodiment, a method may include creating a shadow database on a mass storage device. The method may also include populating the shadow database with data from a production database. The method may further include idling an application accessing the production database to create an idle point in the production database. The method may also include updating the shadow database to the production database.

According to another embodiment, a computer program product may include a non-transitory computer readable medium having code to create a shadow database on a mass storage device. The medium may also include code to populate the shadow database with data from a production database. The medium may further include code to idle an application accessing the production database to create an idle point in the production database. The medium may also include code to update the shadow database to the production database.

According to yet another embodiment, an apparatus includes a memory, a mass storage device and a processor coupled to the memory, and the mass storage device. The processor may be configured to create a shadow database on the mass storage device. The processor may also be configured to populate the shadow database with data from a production database. The processor may further be configured to idle an application accessing the production database to create an idle point in the production database. The processor may also be configured to update the shadow database to the production database.

According to one embodiment, a method may include receiving, at a database manager, a call from a backup utility to copy data from a source file to a destination file. The method may also include performing, at the database manager, a plurality of input/output requests, in response to the call, to copy data from the source file to the destination file. The method may further include returning, to the backup utility, status information regarding completion of the call.

Storing the database on mass storage, rather than tape drive, allows operations, such as from a database manager, with large input/output to improve performance. In contrast, tape drives have a smaller size limit on input/output operations. Further, a backup of the database may be stored on the mass storage device and used as either a backup or an alternate shadow database.

According to another embodiment, a computer program product includes a non-transitory computer readable medium having code to receive, at a database manager, a call from a backup utility to copy data from a source file to a destination file. The medium also includes code to perform, at the database manager, a plurality of input/output requests, in response to the call, to copy data from the source file to the destination file. The medium further includes code to return, to the backup utility, status information regarding completion of the call.

According to yet another embodiment, an apparatus may include a memory and a processor coupled to the memory. The processor may be configured to receive, at a database manager, a call from a backup utility to copy data from a source file to a destination file. The processor may also be configured to perform, at the database manager, a plurality of input/output requests, in response to the call, to copy data from the source file to the destination file. The processor may further be configured to return, to the backup utility, status information regarding completion of the call.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a conventional method of copying a database.

FIG. 2 is a flow chart illustrating an exemplary method of copying a database onto a mass storage device according to one embodiment of the disclosure.

FIG. 3 is a flow chart illustrating an exemplary method of performing a copy with input/output performed by a database manager according to one embodiment of the disclosure.

FIG. 4 is a block diagram illustrating a computer network according to one embodiment of the disclosure.

FIG. 5 is a block diagram illustrating a computer system according to one embodiment of the disclosure.

FIG. 6A is a block diagram illustrating a server hosting an emulated software environment for virtualization according to one embodiment of the disclosure.

FIG. 6B is a block diagram illustrating a server hosting an emulated hardware environment according to one embodiment of the disclosure.

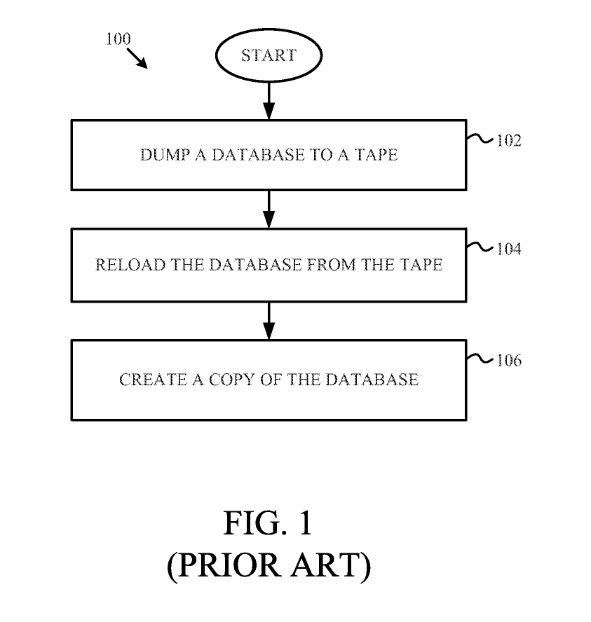

### DETAILED DESCRIPTION

A dump command may be modified to allow creating a copy of the database file in a shadow database on a mass storage device. When the dump command is executed to create the shadow database, the source file may be identified as in a normal dump command, the destination file may be identified using a source file name and alternate database assume parameters, the destination file may be a standard database file format rather than a tape format, history file entries may be created as if the source file was dumped to tape, start timestamps may be created as if the file is dumped using standard dump processing, and/or optional syntax may allow enabling a history file entry for immediate recover. A recover command process may similarly be modified to recognize entries in the dump history corresponding to the dump process described below and handle the history file entries as if the file is dumped using standard dump processing.

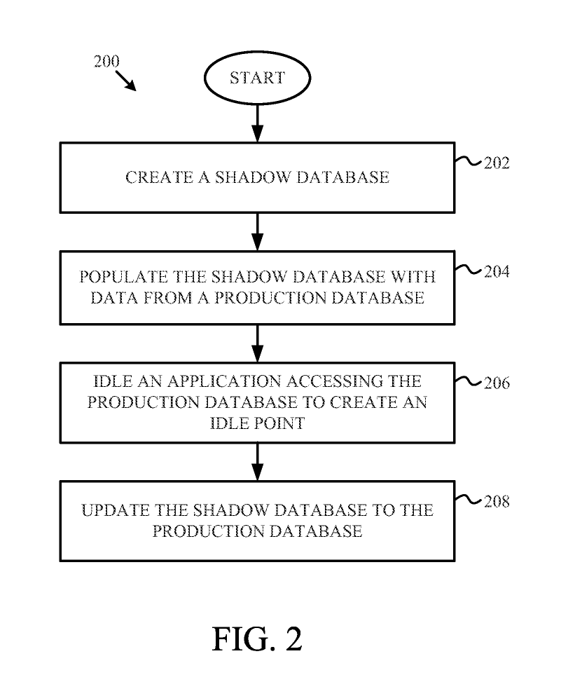

FIG. 2 is a flow chart illustrating an exemplary method of copying a database onto a mass storage device according to one embodiment of the disclosure. A method 200 begins at block 202 with creating a shadow database. The shadow database may become a copy of a production database at completion of the method 200. The shadow database may be stored on a mass storage device, such as a flash drive, a hard disk drive, or a cloud storage system. As part of the creation of the shadow database, alternate file definitions may be created. Alternate file definitions may have different file names, defined as standard database files (connected with a database manager). The alternate file definitions may have some altered characteristics, such as file placement, auditing, maximum size, but may be similar enough that the copied data could be interpreted as if it had been written by the data manager in the first place.

At block 204, the shadow database may be populated with data from the production database. Applications may access the production database during the step at block 204. Thus, the shadow database may be out-of-date with the production database at the end of step 204. However, because the production database may be large in size, the entire database may first be copied to the shadow database, and then updates applied while the application accessing the production database is idled. Thus, the amount of downtime for the application is reduced, when compared to idling the application before populating the shadow database at block 204.

At block 206, the application accessing the production database is idled and an idle point in the production database may be established. The idle point represents a moment in time for which the production database is at a stable state. That is, at the idle point the production database is no longer being updated by an application.

At block 208, the shadow database is updated to the state of the shadow database. The updates may be read from a history file associated with the production database. For example, a timestamp may be recorded at block 204 when the production step begins. Then the history file, such as an audit trail, may be replayed on the shadow database from the recorded timestamp to the idle point.

The shadow database, when stored on a mass storage device, may include similar information to that contained in the production database when the production database is stored on a tape. For example, when the production database is stored on a tape, files may be stored in blocks on the tape along with blocking information. The blocking information may include assembly information to allow reconstruction of files from blocks on the tape. This blocking information may be stored on the mass storage device, just as the blocking information was stored on the tape. Thus, the shadow database may be accessed on the mass storage device just as the production database may be accessed on the tape drive.

Because the shadow database and the production database contain similar information, a redirect may be established within an operating system. When an access to the production database is requested, the access may be redirected to the shadow database. The request may be fulfilled by the shadow database without the requestor aware of the redirect. The redirect may be implemented, for example, where the production database becomes unavailable. The storage of information, such as blocking information, on the mass storage device allows a seamless transition between accessing the shadow database and the production database.

After block 208, the application may be restarted and access to the production database resumed. Updates to the production database may continue to be tracked, such as by examining an audit log for the production database, and the updates may be applied to the shadow database.

The method 200 may be called by issuing a dump command, with or without specified parameters. For example, when the destination of the dump command is a mass storage device, a parameter may be set instructing a computer executing the dump command to execute the method 200 of FIG. 2. In another example, parameters may be specified as part of the dump command to indicate a source and/or a destination file.

When a recovery operation is performed to recover data from the shadow database, three pieces of information may be used to recreate the production database: the data files in the shadow database, a dump history corresponding to the shadow database, and a list of updates, such as an audit log, for the shadow database. According to one embodiment, the dump history may include links to the list of updates.

Performance may be improved during copying of data files, such as databases, by reducing input/output (I/O) requests consumed during the copy operation. For example, a copy between different mass storage devices may involve devices with different size buffers. That is, a first mass storage device may have a buffer of 32K words or smaller, which may be smaller than an I/O size for a second mass storage device.

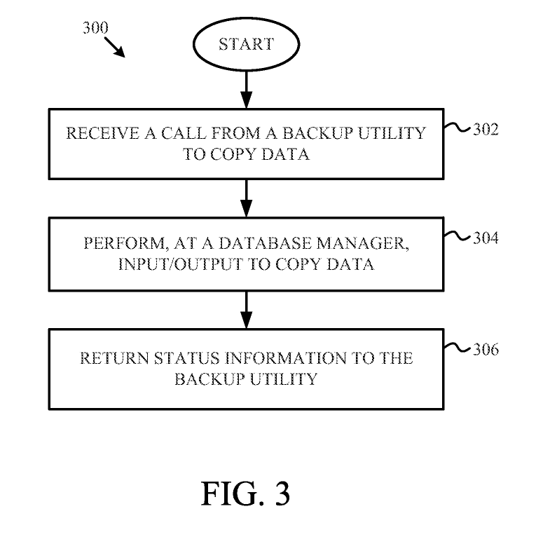

FIG. 3 is a flow chart illustrating an exemplary method for input/output to a storage device according to one embodiment of the disclosure. A method 300 begins at block 302 with a database manager receiving a call from a backup utility to copy data, in which the call may include parameters for a source file and a destination file. The destination file may be a shadow database, and the source file may be a production database. At block 304, a database manager performs input/output to access data at the source file and write data to the destination file. At block 306, the database manager may return status information to the backup utility to allow the backup utility to report the status of the copy operation, such as whether the copy operation was successful or unsuccessful. The backup utility may retain history information regarding copy operations to enable recovery from the shadow database. For example, the backup utility may create an audit log indicating the copy operations completed by the database manager.

By reducing the number of I/O requests performed by the backup utility, I/O costs may be reduced. That is, rather than both the backup utility and the database manager performing input/output requests to the source and destination files, the database manager may perform the majority of the I/O operations during a file copy from, e.g., a tape drive to a mass storage device or a mass storage device to another mass storage device. Further, reducing the number of I/O requests performed by the backup utility reduces problems with lock management. That is, with the database manager performing the majority of the I/O requests, there is a lower likelihood of a lock on a file by the backup utility delaying operations in the database manager. Thus, higher performance may be obtained by concentrating I/O operations within one module of an operating system.

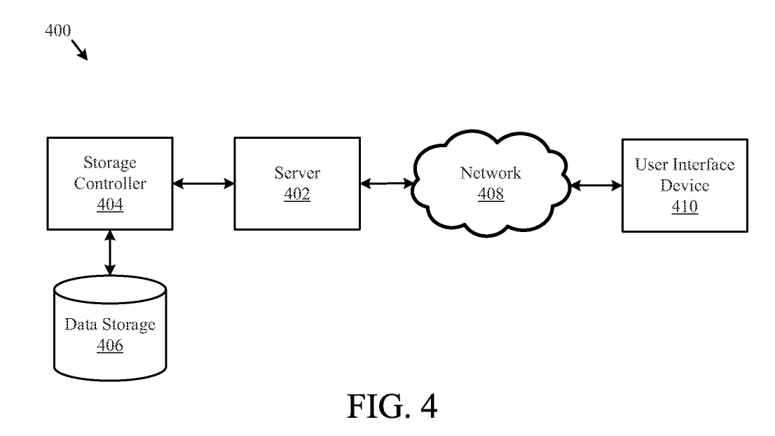

FIG. 4 illustrates one embodiment of a system 400 for an information system, including a system data storage. The system 400 may include a server 402, a data storage device 406, a network 408, and a user interface device 410. The server 402 may also be a hypervisor-based system executing one or more guest partitions hosting operating systems. In a further embodiment, the system 400 may include a storage controller 404, or a storage server configured to manage data communications between the data storage device 406 and the server 402 or other components in communication with the network 408. In an alternative embodiment, the storage controller 404 may be coupled to the network 408. The data storage device 406 may be a tape drive or a mass storage device, such as flash memory, a hard disk drive, and/or a cloud storage system.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area or local area network to access a web application or web service hosted by the server 402 and may provide a user interface for enabling a user to enter or receive information. For example, a user may execute a dump command through the user interface.

The network 408 may facilitate communications of data between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

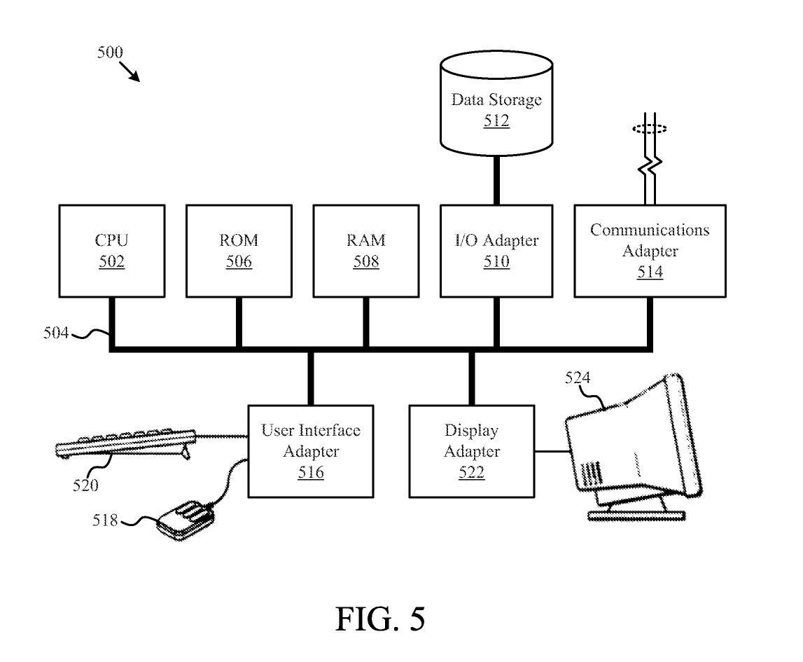

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 706 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 520, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 500 may be virtualized for access by multiple users and/or applications.

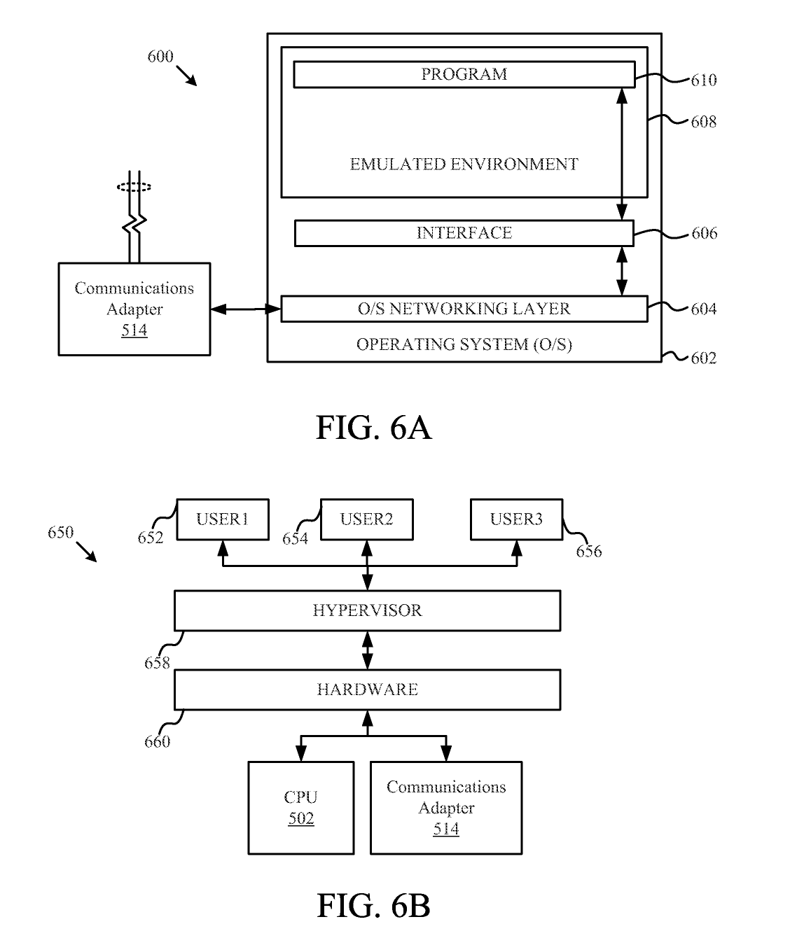

FIG. 6A is a block diagram illustrating a server hosting an emulated software environment for virtualization according to one embodiment of the disclosure. An operating system 602 executing on a server includes drivers for accessing hardware components, such as a networking layer 604 for accessing the communications adapter 614. The operating system 602 may be, for example, Linux. An emulated environment 608 in the operating system 602 executes a program 610, such as CPCommOS. The program 610 accesses the networking layer 604 of the operating system 802 through a non-emulated interface 606, such as XNIOP. The non-emulated interface 606 translates requests from the program 610 executing in the emulated environment 608 for the networking layer 604 of the operating system 602.

In another example, hardware in a computer system may be virtualized through a hypervisor. FIG. 6B is a block diagram illustrating a server hosing an emulated hardware environment according to one embodiment of the disclosure. Users 652, 654, 656 may access the hardware 660 through a hypervisor 658. The hypervisor 658 may be integrated with the hardware 660 to provide virtualization of the hardware 660 without an operating system, such as in the configuration illustrated in FIG. 6A. The hypervisor 658 may provide access to the hardware 660, including the CPU 502 and the communications adaptor 514.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, at a database manager, a call from a backup utility to copy data from a source file to a destination file:
performing, at the database manager, a plurality of input/output requests, in response to the call, to copy data from the source file to the destination file; and
returning, to the backup utility, status information regarding completion of the call.

2. The method of claim 1, in which the source file is a production database and the destination file is a shadow database.

3. The method of claim 2, in which the production database and the copied or shadow database are stored on a mass storage device.

4. The method of claim 3, in which the plurality of input/output requests comprises a request for a block of data from the mass storage drive.

5. The method of claim 2, further comprising tracking, by the backup utility, copy operations performed by the database manager to the shadow database.

6. The method of claim 5, further comprising restoring, by the backup utility, data to the production database from the shadow database.

7. A computer program product, comprising:
a non-transitory computer readable medium comprising
code to receive, at a database manager, a call from a backup utility to copy data from a source file to a destination file;
code to perform, at the database manager, a plurality of input/output requests, in response to the call, to copy data from the source file to the destination file; and
code to return, to the backup utility, status information regarding completion of the call.

8. The computer program of claim 7, in which the source file is a production database and the destination file is a shadow database.

9. The computer program of claim 8, in which the production database and the copied or shadow database are hosted on a mass storage device.

10. The computer program of claim 9, in which the plurality of input/output requests comprises a request for a block of data from the mass storage drive.

11. The computer program of claim 8, in which the medium further comprises code to track, by the backup utility, copy operations performed by the database manager to the shadow database.

12. The computer program of claim 11, in which the medium further comprises code to restoring, by the backup utility, data to the production database from the shadow database.

13. An apparatus, comprising:
a memory; and
a processor coupled to the memory, in which the processor is configured:
to receive, at a database manager, a call from a backup utility to copy data from a source file to a destination file;
to perform, at the database manager, a plurality of input/output requests, in response to the call, to copy data from the source file to the destination file; and
to return, to the backup utility, status information regarding completion of the call.

14. The apparatus of claim 13, in which the source file is a production database and the destination file is a shadow database.

15. The apparatus of claim 14, further comprising
a mass storage device,
in which the production database and the shadow database is hosted on the mass storage device.

16. The apparatus of claim 15, in which the plurality of input/output requests comprises a request for a block of data from the mass storage drive.

17. The apparatus of claim 14, in which the processor is further configured to track, by the backup utility, copy operations performed by the database manager to the shadow database.

18. The apparatus of claim 14, in which the processor is further configured to restoring, by the backup utility, data to the production database from the shadow database.
